(19) United States
(12) Patent Application Publication
(10) Pub. No.: US 2026/0198636 A1
(43) Pub. Date: Jul. 16, 2026

(54) HELMET

(71) Applicant: VOG - IMAGE POLICE INC., TAICHUNG CITY (TW)

(72) Inventor: Gavin Michael VOS, TAICHUNG CITY (TW)

(21) Appl. No.: 19/543,307

(22) Filed: Feb. 18, 2026

Related U.S. Application Data
(63) Continuation-in-part of application No. 17/160,786, filed on Jan. 28, 2021, now abandoned.
Application No. 17/160,786 is a division of application No. 16/232,683, filed on Dec. 26, 2018, now Pat. No. 11,350,687.
Application No. 16/232,683 is a continuation of application No. PCT/CN2017/118675, filed on Dec. 26, 2017.

(51) Int. Cl. A42B 3/12; A42B 3/06; A42B 3/10; A42C 2/00; B29C 44/12; B29C 45/14; B29C 69/02; A42B 3/28; B29K 105/04; B29L 31/00; B29L 31/48

(52) U.S. Cl. CPC A42B 3/125; A42B 3/06; A42B 3/062; A42B 3/105; A42C 2/00; A42C 2/002; B29C 44/12; B29C 45/14; B29C 45/14467; B29C 69/02; A42B 3/28; B29C 2045/14524; B29K 2105/04; B29L 2031/4821; B29L 2031/768

(57) ABSTRACT

A helmet includes a rigid shell having a top portion, two cheek-protection portions extending downward from the top portion, a neck-protection portion connected to the top portion and the cheek-protection portions, two chin-side-protection portions connected to the cheek-protection portions, and a front-chin-protection portion connected to the chin-side-protection portions. A cushioning layer is disposed on the inner peripheral surface of the rigid shell and arranged at the top portion, the cheek-protection portions, the neck-protection portion, the chin-side-protection portions, and the front-chin-protection portion of the rigid shell. A reinforcing member is embedded within the cushioning layer and corresponds to the cheek-protection portions, the chin-side-protection portions, and the front-chin-protection portion of the rigid shell. Accordingly, the cushioning layer is uniformly distributed along the inner peripheral surface of the rigid shell to effectively dispersing external impact forces applied to the rigid shell, and the reinforcing member enhances the overall structural strength of the helmet.

### CROSS-REFERENCE TO RELATED APPLICATIONS

This application is a Continuation-in-Part of copending Application No. 17/160,786, filed on January 28, 2021, which is hereby expressly incorporated by reference into the present application.

### BACKGROUND OF THE INVENTION

### 1. Field of the Invention

The present invention relates to helmets, and particularly to a helmet that can enhance structural strength.

### 2. Description of the Related Art

The shape of a helmet is generally complex. In order to allow a shell and a liner to fit together seamlessly, the manufacturing process typically requires the use of a substantial amount of adhesive, which adversely affects both cost efficiency and weight control of the finished helmet. For cost-reduction purposes, the shell and the liner are therefore often only partially bonded to each other. As a result, gaps are formed in the regions where no adhesive is applied. Such gaps compromise the structural integrity of the helmet, thereby diminishing the level of protection provided to the user.

### SUMMARY OF THE INVENTION

It is a primary objective of the present invention to provide a helmet, which can offer excellent protective performance to a user and effectively enhance the overall structural strength.

To attain the above objective, the helmet comprises a helmet body and a reinforcing member. The helmet includes a rigid shell and a cushioning layer. The rigid shell has an outer peripheral surface and an inner peripheral surface, and the rigid shell is divided into a top portion, two opposing cheek-protection portions monolithically extending downward from left and right sides of the top portion, a neck-protection portion monolithically connected to the top portion and the cheek-protection portions, two opposing chin-side-protection portions provided with rear ends respectively and monolithically connected to the cheek-protection portions, and a front-chin-protection portion monolithically connected to front ends of the chin-side-protection portions. The cushioning layer is disposed on the inner peripheral surface of the rigid shell and arranged at the top portion, the cheek-protection portions, the neck-protection portion, the chin-side-protection portions, and the front-chin-protection portion of the rigid body. The reinforcing member is embedded and fully enclosed within the cushioning layer of the helmet body. A position of the reinforcing member corresponds to the cheek-protection portions, the chin-side-protection portions, and the front-chin-protection portion of the rigid shell.

It can be seen from the above that in the helmet of the present invention, the cushioning layer is uniformly distributed along the inner peripheral surface of the rigid shell. This not only minimizes gaps formed in the rigid shell during manufacturing, but also disperses external impact forces applied to the rigid shell, thereby providing enhanced protective performance to the user. In addition, the reinforcing member, which is fully enclosed by the cushioning layer, further serves to enhance the overall structural strength of the helmet.

Preferably, the reinforcing member includes a front support corresponding to the front-chin-protection portion of the rigid shell and two side support corresponding to the chin-side-protection portion and the cheek-protection portion of the rigid shell. Accordingly, the reinforcing member enhances the overall structural strength of the helmet.

Preferably, the front support has two first engagement portions, and each of the side supports has a second engagement portion detachably engaged with one of the first engagement portions of the front support. Accordingly, the front support and the side supports are individually manufactured and subsequently assembled, thereby increasing manufacturing flexibility and reducing assembly complexity.

Preferably, each of the side supports has a coupling groove, through which the cushioning layer can flow in and fill the coupling groove during manufacturing. After the cushioning layer cures, the bonding strength between each side support and the cushioning layer is enhanced.

Preferably, the helmet body further comprises a plurality of ventilation holes extending through the rigid shell and the cushioning layer. The reinforcing member has a plurality of hollow slots respectively communicating with the ventilation holes disposed at the cheek-protection portions, the chin-side-protection portions, and the front-chin-protection portion of the rigid shell to enhance ventilation in localized regions.

Preferably, a plurality of conical portions are provided around each of the hollow slots and/or each of the coupling grooves. The conical portions serve, on one hand, to maintain an appropriate gap between the reinforcing member and the helmet body so that the cushioning layer can smoothly fill the space between the reinforcing member and the helmet body during manufacturing, and, on the other hand, to increase the bonding strength between the reinforcing member and the cushioning layer.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a perspective view of a helmet of the present invention.

FIG. 2 is another perspective view of the helmet of the present invention, showing that the reinforcing member is embedded and fully enclosed within the cushioning layer of the helmet body.

FIG. 3 is a schematic drawing of the helmet of the present invention, showing that the reinforcing member is embedded and fully enclosed within the cushioning layer of the helmet body.

FIG. 4 is a perspective view of the reinforcing member provided by the helmet of the present invention.

FIG. 5 is an exploded view of FIG. 4.

FIG. 6 is a lateral view of the helmet of the present invention.

FIG. 7 is a sectional view of FIG. 6.

FIG. 8 is a sectional view taken along line 8-8 of FIG. 6.

FIG. 9 is a sectional view taken along line 9-9 of FIG. 6.

### DETAILED DESCRIPTION OF THE INVENTION

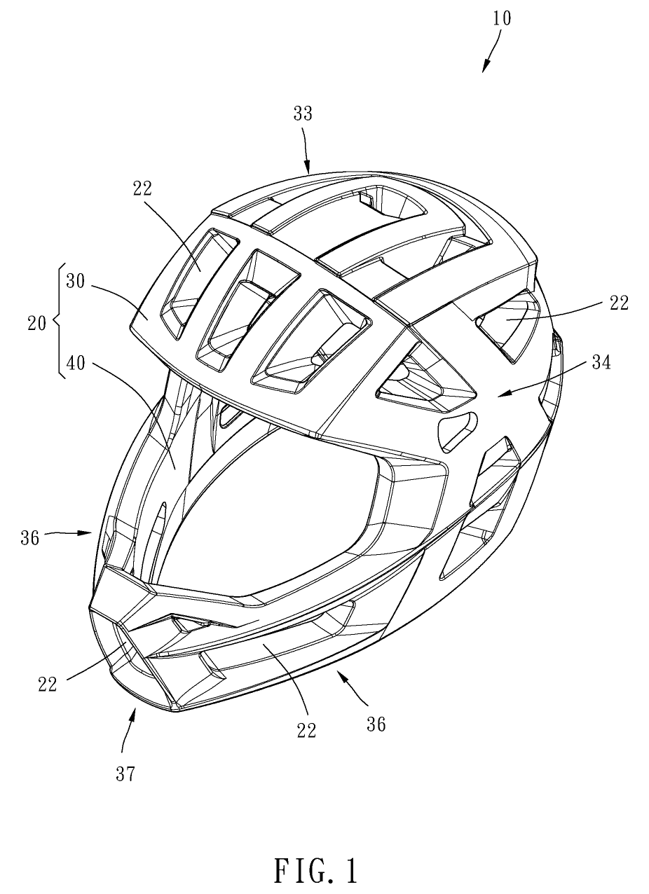

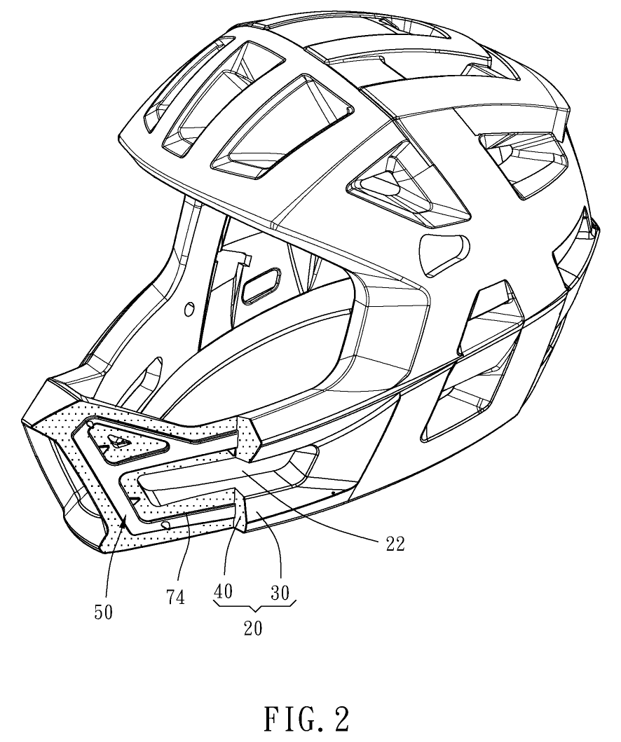

Please refer to FIGS. 1 and 2, a helmet 10 of the present invention comprises a helmet body 20 and a reinforcing member 50.

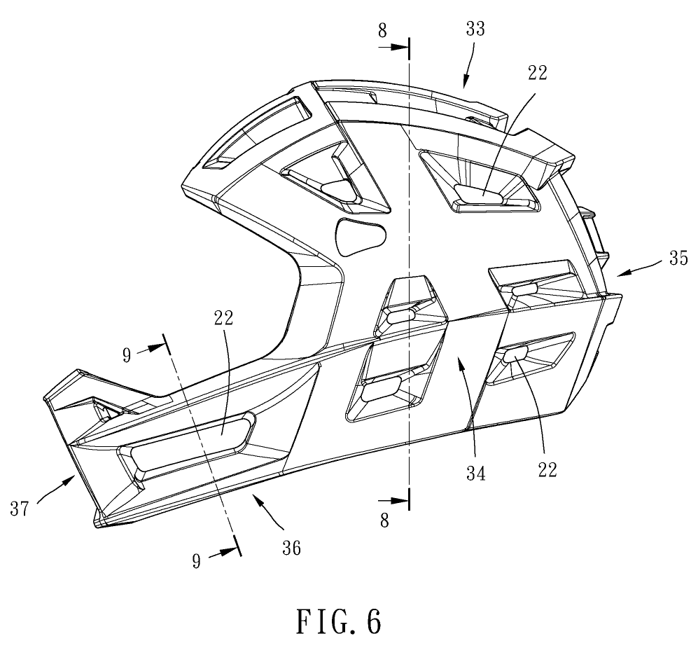

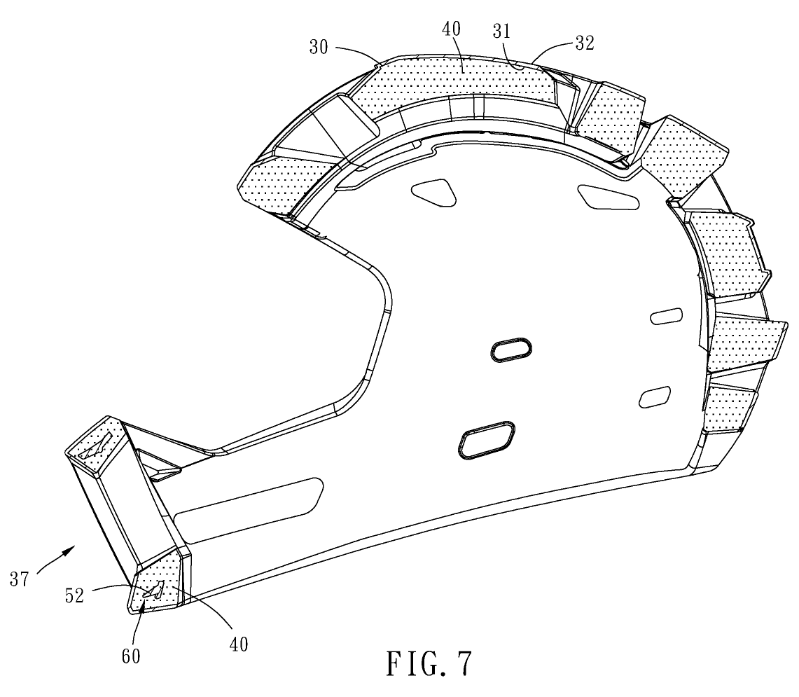

The helmet body 20 includes a rigid shell 30 and a cushioning layer 40. The rigid shell 30 is made of a rigid material such as hard plastic and primarily serves as a first layer of protection. The cushioning layer 40 is made of a shock-absorbing material such as a foamed material and primarily provides shock-absorbing and cushioning effects. As shown in FIGS. 2 and 7, the rigid shell 30 has an inner peripheral surface 31 and an outer peripheral surface 32. The cushioning layer 40 is disposed on the inner peripheral surface 31 of the rigid shell 30. In addition, according to the corresponding protective regions, as shown in FIGS. 1 and 6, the rigid shell 30 is divided into a top portion 33, two opposing cheek-protection portions 34, a neck-protection portion 35, two opposing chin-

side-protection portions 36, and a front-chin-protection portion 37. The two cheek-protection portions 34 monolithically extend downward from the left and right sides of the top portion 33. The neck-protection portion 35 is monolithically connected to the top portion 33 and the two cheek-protection portions 34. The rear ends of the two chin-side-protection portions 36 are respectively and monolithically connected to the two cheek-protection portions 34, and the front-chin-protection portion 37 is monolithically connected to the front ends of the two chin-side-protection portions 36. As for the arrangement of the cushioning layer 40, as shown in FIGS. 7-9, the cushioning layer 40 is distributed at the top portion 33, the two cheek-protection portions 34, the neck-protection portion 35, the two chin-side-protection portions 36, and the front-chin-protection portion 37. That is, the cushioning layer 40 is uniformly distributed along the entire inner peripheral surface 31 of the rigid shell 30. As further shown in FIGS. 1 and 6, the helmet body 20 further has a plurality of ventilation holes 22 extending through the rigid shell 30 and the cushioning layer 40. The size and distribution of the ventilation holes 22 are not limited and may be flexibly adjusted according to practical requirements.

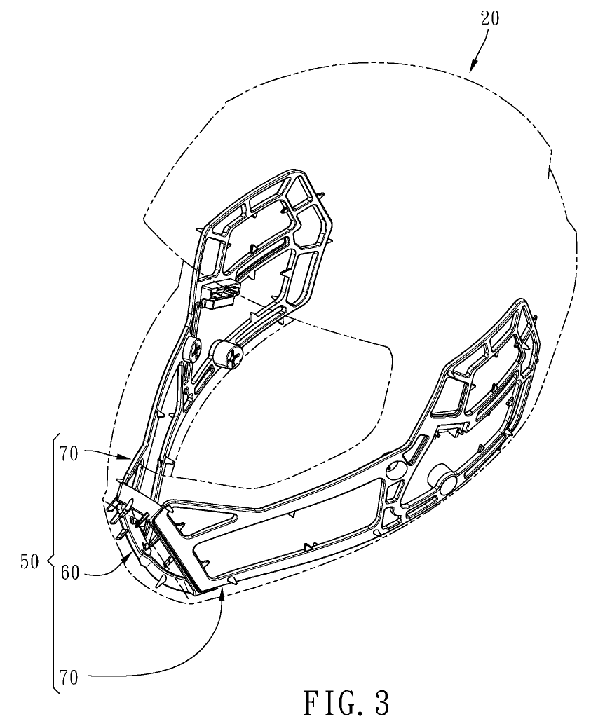

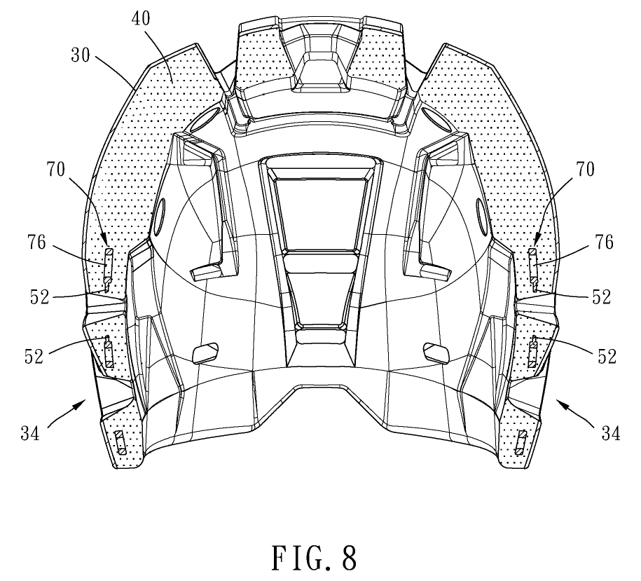

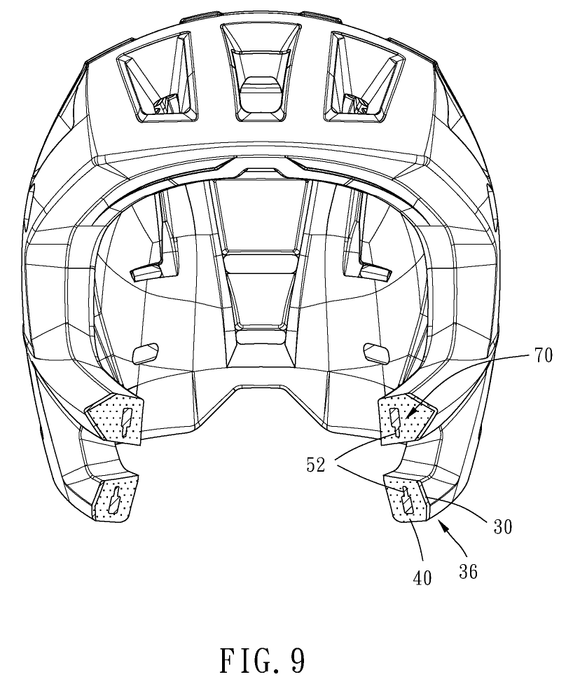

The reinforcing member 50 is made of a material such as Polyamide. As shown in FIGS. 2 and 3, the reinforcing member 50 is embedded within the cushioning layer 40 and is completely enclosed by the cushioning layer 40. The position of the reinforcing member 50 corresponds to the two cheek-protection portions 34, the two chin-side-protection portions 36, and the front-chin-protection portion 37 of the rigid shell 30. More specifically, the reinforcing member 50 includes a front support 60 and two side supports 70. The front support 60 corresponds to the front-chin-protection portion 37 of the rigid shell 30 (as shown in FIG. 7), and the first and rear parts of the two side supports 70 respectively correspond to the two chin-side-protection portions 36 and the two cheek-protection portions 34 of the rigid shell 30 (as shown in FIGS. 8 and 9).

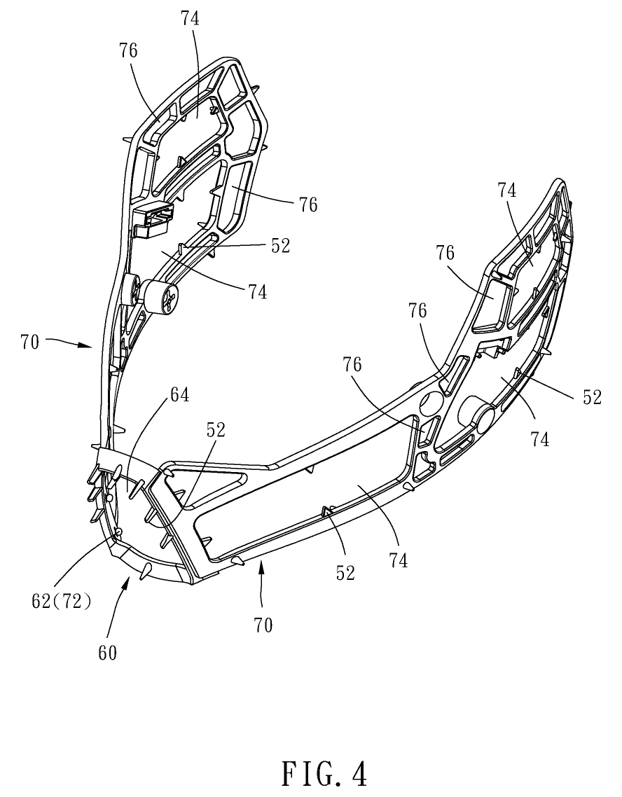

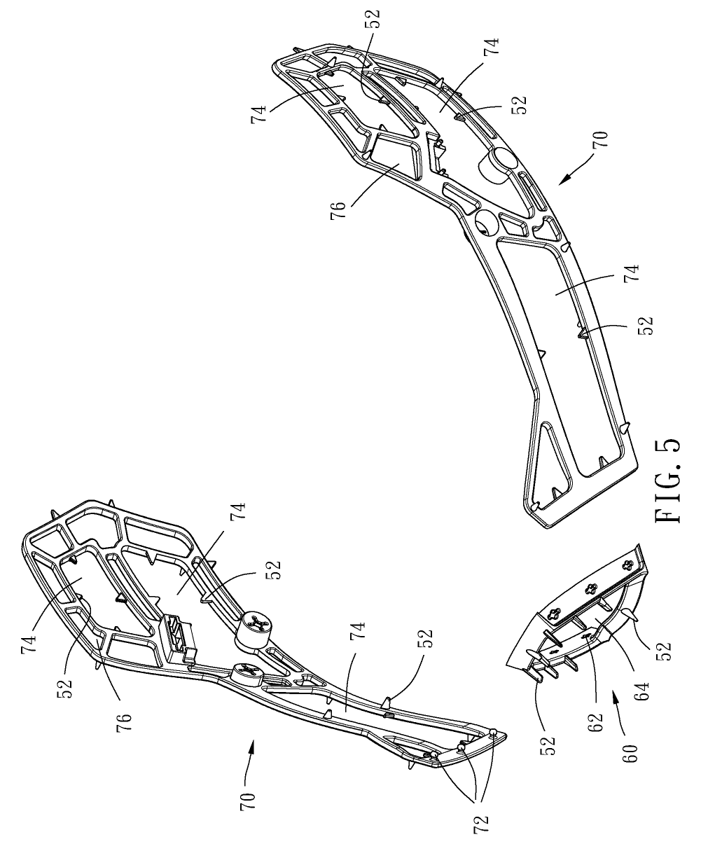

As shown in FIGS. 4 and 5, the front support 60 has three first engagement portions 62 arranged at intervals from top to bottom (for example, slots, although not limited thereto, and in practice at least one is sufficient). The front end of each of the side supports 70 are provided with three second engagement portions 72 arranged at intervals from top to bottom (for example, latches, although not limited thereto, and in practice at least one is sufficient). The first engagement portions 62 of the front support 60 are engaged with the second engagement portions 72 of the side supports 70 in a one-to-one manner, thereby allowing the front support 60 and the two side supports 70 to be assembled in a detachable manner. This configuration increases manufacturing flexibility and reduces assembly complexity. It should be further noted that the front support 60 and the two side supports 70 may alternatively be formed monolithically as a single piece and are not limited to a two-piece structure.

As further shown in FIGS. 7-9, the front support 60 has a hollow slot 64 communicating with the ventilation hole 22 disposed at the front-chin-protection portion 37 of the rigid shell 30. Each of the side supports 70 has three hollow slots 74 respectively communicating with the ventilation holes 22 disposed at the cheek-protection portions 34 and the chin-side-protection portions 36 of the rigid shell 30. This structural arrangement enhances the ventilation performance in localized regions. In addition, each of the side supports 70 is provided with multiple coupling grooves 76 (the number and positions thereof are not limited) around each of the hollow slots 74. The coupling grooves 76 allow the cushioning layer 40 to flow in and fill the grooves during manufacturing, and after the cushioning layer 40 cures, the bonding strength between each side support 70 and the cushioning layer 40 is increased. As shown in FIG. 4, multiple conical portions 52 (the number and positions thereof being not limited) are provided around the hollow slots 64, 74 and the coupling grooves 76. These conical portions 52 serve, on one hand, to maintain an appropriate gap between the reinforcing member 50 and the helmet body 20 so that the cushioning layer 40 can smoothly fill the space between the reinforcing member 50 and the helmet body 20 during manufacturing, and, on the other hand, to increase the bonding strength between the reinforcing member 50 and the cushioning layer 40 after the cushioning layer 40 cures.

As indicated above, in the helmet 10 of the present invention, the cushioning layer 40 is uniformly distributed along the inner peripheral surface 31 of the rigid shell 30. This not only minimizes gaps formed in the rigid shell 30 during manufacturing, but also disperses external impact forces applied to the rigid shell 30, thereby providing enhanced protective performance to the user. In addition, the reinforcing member 50, which is fully enclosed by the cushioning layer 40, further serves to enhance the overall structural strength of the helmet 10.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A helmet comprising:
a helmet body including a rigid shell having an outer peripheral surface and an inner peripheral surface, and divided into a top portion, two opposing cheek-protection portions monolithically extending downward from left and right sides of the top portion, a neck-protection portion monolithically connected to the top portion and the cheek-protection portions, two opposing chin-side-protection portions provided with rear ends respectively and monolithically connected to the cheek-protection portions, and a front-chin-protection portion monolithically connected to front ends of the chin-side-protection portions, the helmet body further including a cushioning layer disposed on the inner peripheral surface of the rigid shell and arranged at the top portion, the cheek-protection portions, the neck-protection portion, the chin-side-protection portions, and the front-chin-protection portion; and
a reinforcing member embedded and fully enclosed within the cushioning layer of the helmet body, a position of the reinforcing member corresponding to the cheek-protection portions, the chin-side-protection portions, and the front-chin-protection portion of the rigid shell.

2. The helmet as claimed in claim 1, wherein the reinforcing member includes a front support corresponding to the front-chin-protection portion of the rigid shell and two side support corresponding to the chin-side-protection portion and the cheek-protection portion of the rigid shell.

3. The helmet as claimed in claim 2, wherein the front support has two first engagement portions, and each of the side supports has a second engagement portion detachably engaged with one of the first engagement portions of the front support.

4. The helmet as claimed in claim 2, wherein each of the side supports has a coupling groove filled with the cushioning layer.

5. The helmet as claimed in claim 1, wherein the helmet body further comprises a plurality of ventilation holes extending through the rigid shell and the cushioning layer, and the reinforcing member has a plurality of hollow slots respectively communicating with the ventilation holes disposed at the cheek-protection portions, the chin-side-protection portions, and the front-chin-protection portion of the rigid shell.

6. The helmet as claimed in claim 5, wherein a plurality of conical portions are provided around each of the hollow slots and each of the coupling grooves.

7. The helmet as claimed in claim 5, wherein a plurality of conical portions are provided around each of the coupling grooves.
